(19) United States
(12) Patent Application Publication
(10) Pub. No.: US 2021/0035247 A1
(43) Pub. Date: Feb. 4, 2021

(54) METHOD FOR EFFICIENT CONTRACT PREPARATION, REVIEW AND NEGOTIATION

(71) Applicant: Arthur C. Swanson, Allen, TX (US)

(72) Inventor: Arthur C. Swanson, Allen, TX (US)

(21) Appl. No.: 16/983,257

(22) Filed: Aug. 3, 2020

Related U.S. Application Data
(60) Provisional application No. 62/881,430, filed on Aug. 1, 2019.

(51) Int. Cl. G06Q 50/18; G06N 20/00; G06N 5/04; G06Q 10/10; H04L 29/06; G06F 3/0482

(52) U.S. Cl. CPC G06Q 50/188; G06N 20/00; G06F 3/0482; G06Q 10/101; H04L 63/0428; G06N 5/04

(57) ABSTRACT

An internet-based method is provided for preparation, review and negotiation, of contracts in an efficient and focused manner. More particularly, the method employs a computer application operable on any type of computing device by two or more parties and focuses their attention on the most important and most negotiated contract clauses. Several options and capabilities are provided, including the ability of parties to select desired contract clauses from a database, and designate which clauses are vitally important, as well as generally important and universally applicable (boilerplate) clauses. The computer application can then be instructed to share and display subsets of the contract clauses selected by all parties, such as only the vitally important clauses, or only clauses having edited variable content, for initial focused negotiation and settlement, before turning to review and negotiation of less important or less critical clauses.

### CROSS-REFERENCE TO RELATED APPLICATIONS

The present application claims the benefit of U.S. Provisional Application No. 62/881,430 filed on Aug. 1, 2019, the entire disclosure of which is hereby incorporated by reference herein.

### FIELD OF THE INVENTION

The present invention relates generally to a method for preparation, and subsequent review and negotiation, of contracts. More particularly, the present invention relates to a method for preparing a contract which enables focus on the most important and most negotiated clauses and aspects of those clause, and which may be implemented using an internet-based application to streamline contract preparation, review and negotiation while increasing both clarity and efficiency.

### BACKGROUND OF THE INVENTION

There are an infinite number of types of written agreements (contracts), with just as many possible purposes. All contracts include a number of clauses, often a large number, whose content dictates the scope of the agreement between the parties, as well as the rights and obligations of the parties under the contract. Many different categories and types of clauses are possible which, in turn, may have widely varied content depending on the clause's intended meaning and purpose in a particular contract.

All contracts are also the product of some degree of review, consideration, negotiation and agreement among one or more parties concerning the types of clauses to be included in the contract, as well as their specific content. The time and effort required for each party to prepare, review negotiate and agree on the clauses and their content for a contract also vary widely. Depending on various factors relating to the interests and intentions of the parties and the surrounding circumstances, some clauses will necessarily be more important than others to one or more of the parties. For example, the relative importance of clauses being contemplated for a contract may range from vitally material (“make or break”), to generally material, to standard, to entirely optional, and combinations of these.

The conventionally practiced method for preparing, reviewing and negotiating contracts generally begins with one of two methods. In the first, one party prepares a complete proposed first draft of a contract which includes all clauses to be included, regardless of relative importance, and all content of those clauses, whether typically negotiated content or not. Generally, that full draft contract will contain clauses and content customized to the drafting party's preferred standards and precedents. Because the contract received is a full contract with all clauses and content customized to the drafting party's preferences, the receiving party must generally then review the entire proposed contract and provide feedback and counterproposals for review and consideration by the drafting party. This is often the case even if many clauses and their content are common ones with few negotiated variables, less important and less negotiated clauses, or even material clauses with fairly common language across contracts set apart by key variable content in those clauses. The parties go back and forth in this manner until all clauses and their content are agreed upon. This approach is inefficient, and in some cases wasteful, because time and effort are spent reviewing and negotiating several clauses of less importance or the less important content in material clauses, rather than focusing on the key clauses and key variable content of those clauses. This approach also can lead to less clarity or understanding of key terms, particularly by non-lawyer clients of the negotiating parties, with all clauses and content, regardless of importance, being contained in a full-length custom agreement.

In another conventional method, one party may draft a term sheet with only certain key or material items to be agreed upon by the parties before the parties begin preparation, review and negotiation of a full contract. After the parties' agreement on those key term sheet items, the process restarts with the above conventional method whereby one party prepares a complete proposed first draft of a contract which includes not only the agreed term sheet items, but also all other clauses to be included, regardless of relative importance, and all content of those clauses, whether typically negotiated content or not. The review and negotiation process generally follows the same process outlined above with the same limitations and inefficiencies.

The invention described and contemplated herein provides a method for simplified preparation, review and negotiation of a contract which addresses the foregoing limitations and inefficiencies of the conventional methods described above.

### SUMMARY OF THE INVENTION

The invention described and contemplated herein relates to a method for preparation of a contract between two or more parties which enables the parties to focus review and negotiation on one or more material clauses and their material negotiated content, while preserving and supporting agreement on the less material clauses and content in the parties' contract. The method enables parties to minimize spending time and effort on clauses and content which are not as material. The method may be practiced using a computer application which may be internet-based and implemented through a website.

### DETAILED DESCRIPTION OF THE INVENTION

Detailed embodiments of the present invention are disclosed herein. It should be understood that the disclosed embodiments are merely illustrative of the invention which may be embodied in various forms. In addition, each of the examples given in connection with the various embodiments of the invention is intended to be illustrative, and not restrictive. All uses of the phrases “for example” or “such as” are merely examples of the feature(s) being described and are not the only embodiment or suitable alternative and are not to be interpreted as limiting, regardless of whether accompanied by the phrase “without limitation.”

The invention contemplated and described herein is a method for preparing, reviewing and negotiating a contract with improved efficiency by enabling parties to focus on review, negotiation and agreement of the most important clauses and their content, while recording and preserving agreement on settled (i.e., already-agreed upon) clauses and their content, as well as less important clauses and content and universally applicable clauses and content. The method may be performed by parties preparing, reviewing and negotiating a contract using a computer application accessed through an internet-based website.

More particularly, the method and the internet website provide efficient and streamlined preparation, including review and negotiation, of contracts by allowing parties to view, negotiate and agree to one or more of the most important clauses and their content by separately displaying each such clause and/or its key variable content for review and negotiation by the parties, while also recording and retaining the standard (i.e., not typically negotiated) content for such clauses, as well as any settled clauses and settled key variable content. If desired, both the variable and standard content of the most important clauses can be displayed for continued consideration by the parties. However, enabling the separate display and consideration of key variable content, while retaining but not displaying standard content and settled clauses enhances the focus, clarity and efficiency of the review and negotiation process. Further, the method and internet website further provide for efficient and streamlined preparation, including review and agreement, of contracts by default inclusion and incorporation of universally applicable (e.g., “boilerplate”) clauses and content and other standard clauses and content for all agreements or certain types of agreements.

Written agreements (contracts) routinely contain many clauses or provisions which set forth requirements, limitations, parameters, definitions, and rights and obligations of the one or more parties who will ultimately execute and be bound by the contract. When the content of all necessary and desired clauses is agreed upon by the parties, an agreement (“meeting of the minds”) is formed and a contract is typically finalized and executed by each of the parties to memorialize all the clauses of the contract and evidence each parties' intent to perform under and be bound by those clauses.

Depending on various factors including purposes or goals, interests of the parties, available resources and capabilities of the parties, and circumstances often relating to economic, environmental and social conditions, some clauses will be more important than others, ranging from critical (“make or break”) to entirely optional, to one or both parties.

Depending on the nature of the surrounding circumstances, the purpose(s) of the agreement and the relationship between the parties, different types of clauses will typically be included in the contract which governs the parties' rights and obligations. Of course, there are endless variations of circumstances and purposes for which parties negotiate with the intent of reaching agreement and entering into a binding executed contract.

While each of the clauses of a contract are important, in every situation the parties will consider at least one or more of the clauses under negotiation to be the most important (i.e., “make-or-break”) clauses such that unresolved disagreement over them and their content will prevent formation of an agreement.

Additionally, the parties will consider some clauses to be generally material clauses, the content of which must also be agreed upon by all parties before formation of an agreement can occur, but which, for various possible reasons, are expected to be more easily negotiated and agreed upon. For example without limitation, there may be fewer realistic options for some clauses, or one or more parties is more flexible concerning certain clauses, so that even though such clauses are necessary to form a complete agreement, they require less negotiation than vitally material clauses and, therefore, are considered generally material clauses.

The parties also generally expect that there will be several standard clauses and boilerplate clauses in the contract which ultimately arises from negotiations and agreement. Standard clauses are those which are typically expected to be present in a contract but, for various reasons, require little consideration and negotiation concerning their content to reach agreement between the parties. For example, a clause which is not a material clause (either vitally or generally) and requires little deliberation to select from among possible alternatives would typically be considered a standard clause. As another example, a clause which is not a material clause (either vitally or generally) and for which the relevant circumstances or purpose of the contract dictate only a very small number (i.e., 1-4) of alternatives for consideration, may be considered a standard clause. As still another example, a clause which is not a material clause (either vitally or generally) and which may be present in or absent from the contract without jeopardizing the validity of the contract or altering or contradicting any vitally or generally material clause of the contract, may be considered a standard clause.

Boilerplate clauses are those which may involve even less deliberation and negotiation than standard clauses and may even be absent from the contract without much risk to any parties' rights or obligations under the contract. For example without limitation, boilerplate clauses may be omitted from the contract without effecting the meaning or applicability of clauses that are included in the contract. In addition, or alternatively, boilerplate clauses are those whose content and effect may not be necessary, but often included as useful or advisable to include in contracts based on the relevant industry, circumstances, or purpose(s) and are not typically highly negotiated.

It is generally understood and expected that which clauses constitute vitally material clauses, generally material clauses, standard clauses and boilerplate clauses, will vary and be determined based at least in part upon the subject matter, context, purpose and various other factors at the time of negotiation, as well as according to the judgment of each party. Furthermore, it is recognized and often happens that a particular clause which is a vitally material clause for one contract may instead be a generally material clause, or even only a standard clause in another, different contract. This can be true even where the clause is required to be included in both contracts. It is also possible and common for a particular clause to be a vitally material clause for one type of contract, but completely optional or even not applicable for another type of contract.

Where the parties cannot reach agreement on all vitally material clauses for a particular situation or deal, no meeting of the minds occurs and preparation of a written contract is unnecessary. Occasionally, discussions between the parties quickly reveal that there will be no acceptable agreement upon vitally material clauses. But, at other times, such realization may not occur until some negotiation, or even prolonged negotiation, has occurred between the parties.

Conventional contract preparation, review and negotiation methods involve the creation, exchange and review of a complete proposed draft contract which includes all proposed clauses, including one or more most important clauses, one or more generally important clauses, and often many standard and boilerplate clauses. The result is that a drafting party provides to a receiving party a proposed contract comprising several pages which include twenty or thirty, or fifty or even more, clauses, many of which may be biased in favor of the drafting party and only a handful of which (i.e., the vitally material clauses) typically merit initial focused consideration by the parties. This causes distraction and extended review and response times for the receiving party. This is because the receiving party must either read and consider all the clauses and provide feedback and counterproposals for all clauses with which there is disagreement, or at least briefly review all the clauses to determine which are the vitally material clauses and then return to read and consider only the vitally material clauses, before providing feedback and counterproposals for only the vitally material clauses. Where the receiving party provides feedback and counterproposals on all clauses with which there is disagreement, instead of only for vitally material clauses, the distraction and extended review and response time is also unnecessarily extended for the drafting party upon receipt of the receiving party's response.

To address the foregoing shortcomings and inefficiencies of conventional methods, the present method involves selection by one or more of the parties of one or more clauses desired by each to be included in the contract. The clauses are selected from a list or database comprising a plurality of clauses, each of which is independent and not drafted by or biased toward any party (i.e., objective, rather than from a source unique to one party). Furthermore, each clause includes either: (1) only variable content which is modifiable and, therefore, negotiable, (2) only standard content which is not modifiable, and (3) both variable content and standard content. Standard non-modifiable content and modifiable content are clearly delineated in the list or database. Accordingly, a clause having only standard content will generally be negotiated as being either included in the contract or not in its entirety. On the other hand, a clause having only variable content will generally be negotiated to determine whether it is included in the contract or not, as well as, if it is included in the contract, to determine whether its variable content is agreed upon by all parties or must be further negotiated. Finally, a clause having both variable and standard content will be negotiated as a combination of the foregoing approaches.

It should also be noted that the standard content of any particular clause includes at least one standard provision. Similarly, the variable content of any particular clause includes at least one variable provision. Where a clause includes more than one variable provision, each one may be negotiated and modified independently from the others.

For each selected clause which includes variable content, at least one party also selects or provides at least one desired value for the variable content. In some embodiments, the desired value is a pre-defined value selected from a list of possible pre-defined values associated with the variable content. In some embodiments, the desired value is freeform and provided by a party. In some embodiments, the desired value may be either a pre-defined value or a freeform value provided by a party. In some embodiments, more than one desired value may be selected or provided by a party for consideration by the other party or parties. For a clause having variable content which includes more than one variable term, at least one desired value is selected or provided for each such variable term.

In some embodiments, the selecting party (who selected the clause including variable content for inclusion in the contract) selects or provides the desired value, and each of one or more other parties reviews the desired value and either selects and agrees to one or more of them, or proposes one or more of their own different desired values for consideration by the selecting or other parties. In some embodiments, each party selects or provides at least one desired value for the variable content of a selected clause or for at least one of multiple variable terms in a selected clause. In some embodiments, one or more parties may designate an associated preference for a desired value for variable content or terms, where the associated preference is selected from (1) most preferred, (2) acceptable (optionally with rank order of preference), (3) not acceptable, or (4) no preference.

After the parties have selected at least one proposed clause from the list or database of clauses and selected or provided at least one proposed desired value for each variable content, the next step of the method for review, negotiating and completing a contract is comparing the proposed clauses and proposed desired values and identifying any settled clauses, unsettled clauses, and settled and unsettled variable content. More particularly, the method further comprises comparing and matching all of the proposed clauses selected by all parties and:

(1) identifying and designating any settled standard clauses from among the proposed clauses, wherein settled standard clauses are proposed clauses which include only standard content and have been selected by all parties;

(2) identifying and designating any unsettled standard clauses from among the selected clauses, wherein unsettled standard clauses are selected clauses which include only standard content and have been selected by less than all parties;

(3) identifying and designating any settled variable clauses from among the proposed clauses, wherein settled variable clauses are proposed clauses which have been selected by all parties and which include variable content all of which has been agreed upon by all the parties;

(4) identifying and designating any unsettled variable clauses from among the proposed clauses, wherein unsettled variable clauses are:
(a) any proposed clauses which include variable content and have been selected by fewer than all the parties,
(b) any proposed clauses which include variable content, have been selected by all the parties, but the variable content of which has not been agreed upon (i.e., the unsettled variable clause includes at least one variable provision for which one or more of the desired values selected or proposed by the parties do not match), wherein the variable content not agreed upon are unsettled variable content.

In some embodiments, where each party has selected or provided one or more proposed desired values for each variable provision and also designated an associated preference selected from (1) most preferred, (2) acceptable (optionally with rank order of preference), (3) not acceptable, or (4) no preference, for each proposed desired value, the method further comprises, for each variable provision, comparing and identifying any matching, and therefore settled, proposed desired values which have been designated with either (1) most preferred or (2) acceptable.

After comparing the proposed clauses and proposed desired values and identifying any settled standard clauses, unsettled standard clauses, unsettled variable clauses, and unsettled variable content, the method according to the present invention further includes displaying to the parties only one or more of: the unsettled standard clauses, the unsettled variable clauses and the unsettled variable content. In some embodiments, the method includes displaying only the unsettled variable clauses and unsettled variable content.

While all of the clauses in the list or database of clauses are selectable by any of the parties, depending on the type of contract and its subject matter, one or more of the clauses may be included, by default, as universally applicable clauses in the contract. As will be familiar to persons of ordinary skill in the relevant art, universally applicable clauses are general provisions included in nearly all contracts, but not typically the subject of negotiation (often referred to as, but not limited to, “boilerplate” clauses). Any party may propose removal of any one or more of such universally applicable clauses included by default, and other parties may consider the proposed removal. Accordingly, in some embodiments, after the parties have selected at least one proposed clause from the list or database of clauses and selected or provided at least one proposed desired value for each variable content, the method may further comprise comparing and matching all of the proposed clauses selected by all parties and:

identifying and designating any settled universally applicable clauses which are universally applicable clauses which remain unrejected by any party; and

identifying and designating any unsettled universally applicable clauses which are universally applicable clauses which have been rejected by any party.

In another exemplary embodiment, the method for preparation of a contract by at least a first party and a second party, using a list or database comprising a plurality of clauses, each of which is independent and not drafted by or biased toward any party (i.e., objective, rather than from a source unique to one party) comprising the following steps performed by one or both of the first and second parties:

(A) selecting one or more proposed clauses from the list or database, each of which includes: (1) only standard content, (2) only variable content, or (3) both standard content and variable content;

(B) selecting and/or editing variable content of selected clauses;

(C) providing the selected and edited clauses, along with access to the list or database of clauses, to the first party, the second party, or both; and

(D) negotiating and reaching agreement on the selected standardized and optional clauses, including their variable content.

In still another exemplary embodiment, the method for preparation of a contract by at least a first party and a second party is performed using a computer application accessed through a user interface (an internet-based website) in communication through the internet with a computer application which includes or is capable of accessing: the above-described list or database comprising a plurality of clauses, each of which includes an associated type, standardized content, and certain of which contain editable variable content, at least a first party record which includes a first party name and login credentials, and a second party record which includes a second party name and login credentials;

wherein the computer application is capable of allowing the first and second parties:

to access and view all clauses in the list or database, access and view all universally applicable clauses included by default in the contract, access and view all variable content of each clause separately from its standardized content,

automatically incorporate universally applicable clauses into the parties' agreement, select, incorporate and save one or more of proposed clauses from the list or database into the parties' agreement,

edit, incorporate and save any variable content of the selected proposed clauses into the parties' agreement, while not reviewing or editing any of the clauses' standardized content,

and wherein the computer application is capable of receiving and storing one or more draft agreements which comprise such clauses,
said method comprising the following steps performed by one or both of the first and second parties:

(A) drafting, or selecting from the plurality of clauses of the list or database, each of which will have standardized content and may have certain editable variable content;

(B) editing the variable content of such clauses;

(C) providing the one or more standard or optional clauses only with its edited variable content to the first party, the second party, or both;

(D) optionally, sending the clause(s)'s standardized content

(E) optionally, viewing the one or more clauses (with its editable variable content and its standard content) on the website.

In one embodiment, the computer application is a mobile application configured to operate on a smartphone, pad computer, or other computer device. The computer application is operable to use various programming languages and user interfaces automatically to provide pre-defined contracts, contract provisions, or data sets for display via the computer application. For example and in one embodiment, upon launching the computer application a first menu is displayed such that the user can select the type of contract needed. The “type” of contract can include options such as confidentiality or non-disclosure agreement, software license, services contract, or other contract that is pre-defined and automatically loaded into the computer application without user input. Another potential option that can be displayed on the first menu or second menu is the “geography” options related to the contract, which for example can include contracts governed by U.S. law, certain state law (e.g., Texas), administrative agency, international jurisdiction or the like. If a user selects the “geography” type through the user interface of the computer application, then the computer application automatically loads and/or displays contracts associated with the geography of the contract. In one embodiment, the computer application, upon receiving an input as to the “type” and “geography” of the contract, automatically loads pre-defined contracts that are of the 1) type and 2) geography identified by the user. In another embodiment, the first, second, or third menu can provide a radio button, dropdown menu, or other user interface option for the computer application to receive input from the user on the “amount” of the contract. Upon receiving input on the amount (monetary, number of products, or scope of the contract for services), certain pre-defined contracts or contract options are made available to the user via a menu, multiple-menu display, or other user interface mechanism. In this embodiment one or more base contracts are provided for the user to select from and these contracts are predefined. In addition, one or more provisions for certain variable provisions such as indemnity, representations and warranties, or termination, for example, are displayed on the menu of the computer application.

In one embodiment, the base contract can be displayed in the center of the display and one or more variable menu options can be displayed at the same time as the base contract, within the contract from a user interface perspective (inline), or to the left or right of the base contract. A custom provision, optionally, can be used on the right or left side of the user interface display that allows one or more users to create custom provisions, which upon submission via the computer application automatically change the existing provision in the base contract to the custom provision, show the change via redline, highlight, or other mechanism as well as log the change for version control purposes. The computer application is also configured to allow one or more users access to a workspace, which is a section of the computer application that would apply to all parties for a given transaction, business relationship, etc. For example, a first user can include the email addresses of other users and upon submission, the computer application can create a new workspace or share the existing workspace with the new users automatically without user interaction. Optionally the computer application is configured to provide logged events related to the workspace automatically and without user intervention if this option is selected for a given workspace. Such reporting functionality, which is not limited to log even reports, can be performed via XML, Flash, Adobe PDF, or database format, or other format upon receiving a selection from the user on format or automatically given pre-determined settings for the computer application.

In another embodiment, the computer application is configured to receive input via voice control, voice, or voice inputs as well as gestures received via the user interface of a smartphone, pad computer, or computing device. For example, the computer application is configured to receive, parse, and/or identify the speech then automatically apply the voice command to capabilities to the system without manual interaction by the user. For example, the user could say, “display a software licensing agreement, with geography Texas, for a $5 million contract,” and the computer application can automatically display one or more contracts meeting the criteria to the user. The computer application also comprises an artificial intelligence engine, which is a software, hardware, algorithms, and/or software tools configured to 1) alert a user of a similar contract provision previously agreed to by a user; 2) develop a custom contract based upon type, geography, and/or amount where the artificial intelligence engine based upon pre-defined and pre-existing contracts or contract provisions is configured to develop a first draft of a contract based upon any combination of type, geography, or amount. The computer application is also configured to receive one or more and in some cases thousands of previously agreed to contracts, where the computer application via the artificial intelligence engine ingest these contracts, parse the provisions and store provision based upon the type of contract provision, and/or identify the most commonly accepted provisions based upon the contract ingested by the computer application. For avoidance of doubt, ingesting means receive in electronic form via XML, database, list, PDF, Word, or other format one or more contracts to train the artificial intelligence engine.

In one embodiment, there is a first computer application on a computing device such as a laptop, desktop, server, or other computing device and this computer application is configured to receive input, data, or user selections made on a second computer application executing or otherwise operating on a smartphone or pad computing device. One non-limiting example in this embodiment includes a user making a redline via the second computer application, and where the second computer application is configured to send the redline change to the first computer application. Upon receipt of such a selection by the first computer application, the first computer application is configured to hold the selection and/or input for approval by a user, automatically make the change, automatically make the change and send an updated contract to all parties via email or via a link to access the next contract via the first computer application, or simply make the change in the first computing application. The system is configured to run on one or more computers including cloud-based computing platforms. Such cloud-based computing platforms may also be used to store data or as one version of a computer application that is configured to integrate with a second computer application running on a desktop, laptop, pad computing device, or smartphone that is remote from the first computer application which employs a cloud-based architecture.

In some embodiments, the contract may be negotiated and prepared by two or more parties. Additionally, it should be understood that for embodiments implemented using a computer application accessible through an internet-based website, the parties may also be referred to as “users.”

In some embodiments, the computer application is configured such that universally applicable clauses or standard content of any proposed clauses do not have to be viewed by the parties in connection with each negotiation and agreement.

In some embodiments, the computer application is capable of storing, retrieving and displaying, or otherwise allowing one or more of the parties to view one or more of the selected proposed clauses according to the associated type along with only the associated limited variable content for each selected clause. In some embodiments, the computer application is configured to allow the parties to alternate views of the selected clauses between viewing only its associated type and its variable content, and viewing the above together with the clauses full standardized content.

In some embodiments, the application is further configured to allow for users of the application to preselect preferences of such user for certain variables from the standardized content of clauses, which may include ranked preferences for certain iterations of such variables, including preference choices of not acceptable and no preference.

In some embodiments, the application is configured to allow comparison of the preferences for certain variables of each user against other users to match the most highly ranked mutual preference between the users in connection with negotiation of an agreement between those users.

It will be understood that the embodiments of the present invention described hereinabove are merely exemplary and that a person skilled in the art may make variations and modifications without departing from the spirit and scope of the invention. All such variations and modifications are intended to be included within the scope of the present invention.

I claim:

1. An internet-based contract preparation method which employs one or more user interfaces in communication through the internet with a contract preparation and agreement application, wherein the contract preparation and agreement application is accessible and operable, through the one or more user interfaces, by users comprising at least a first party and a second party negotiating a contract, and includes or is capable of accessing a clauses database comprising a plurality of clauses, each clause including:
(A) one or more optional importance indicators selectable from one or more of:
(1) vitally important,
(2) generally important,
(3) standard,
(4) universally applicable, and
(5) unassigned,
(B) content comprising:
(1) variable content comprising one or more variable provisions, each of which is independently modifiable by selecting or editing one more variable provision values from:
(a) a predefined value,
(b) a free-form value, or
(c) a combination thereof,
wherein each of the one or more variable provision values optionally includes an associated preference selected from:
(i) most preferred,
(ii) acceptable (or a rank order of acceptability)
(iii) not acceptable, and
(iv) no preference,
(2) standard content which comprises one or more standard provisions each of which is not modifiable, or
(3) both variable content and standard content, the internet-based contract preparation and agreement method comprising the steps of:
(I) selecting one or more desired clauses from the clauses database and designating at least one importance indicator for each selected desired clause, wherein:
(A) when the desired clause comprises variable content, for each variable provision, also selecting at least one proposed variable provision value and, optionally, designating an associated preference, and
(B) when the at least one proposed variable provision value is a free-form value, also providing content for the free-form value,
wherein the one or more desired clauses selected by the first party are first party desired clauses and the one or more desired clauses selected by the second party are second party desired clauses; and
wherein the application receives and records all selections made in Step (I) by the first and second parties on either local or remote data storage media;
(II) after Step (I) is completed by both of the first and second parties, notifying or instructing the application to compare and match all of the first party desired clauses with all of the second party desired clauses,
(III) either during or after performance of Step (II) notifying or instructing the application to identify and designate all settled clauses, unsettled clauses, and settled and unsettled variable content by:
(1) identifying and designating any settled standard clauses from among the proposed clauses, wherein settled standard clauses are proposed clauses which include only standard content and have been selected by all parties;
(2) identifying and designating any unsettled standard clauses from among the selected clauses, wherein unsettled standard clauses are selected clauses which include only standard content and have been selected by less than all parties;
(3) identifying and designating any settled variable clauses from among the proposed clauses, wherein settled variable clauses are proposed clauses which have been selected by all parties and which include variable content all of which has been agreed upon by all the parties; and
(4) identifying and designating any unsettled variable clauses from among the proposed clauses, wherein unsettled variable clauses are:
(a) any proposed clauses which include variable content and have been selected by fewer than all the parties,
(b) any proposed clauses which include variable content, have been selected by all the parties, but the variable content of which has not been agreed upon (i.e., the unsettled variable clause includes at least one variable provision for which one or more of the desired values selected or proposed by the parties do not match), wherein the variable content not agreed upon are unsettled variable content.

2. The internet-based contract preparation method of claim 1, wherein when each of the parties has selected or provided one or more proposed variable provision values for each of the one or more variable provisions and also designated an associated preference for each proposed variable provision value, the method further comprises, for each variable provision, comparing and identifying any matching and, therefore, settled proposed variable provision values which have been designated with either (1) most preferred or (2) acceptable.

3. The internet-based contract preparation method of claim 2, further comprising, (IV) after identifying any settled standard clauses, unsettled standard clauses, unsettled variable clauses, and unsettled variable content, displaying to the parties only one or more of:
(1) the unsettled standard clauses,
(2) the unsettled variable clauses, and
(3) the unsettled variable content.

4. The internet-based contract preparation method of claim 3, wherein step (IV) includes displaying only the unsettled variable clauses and the unsettled variable content.

5. The internet-based contract preparation method of claim 1, further comprising selecting one or more of the plurality of clauses in the clause database and designating the importance indicator of (4) universally applicable (boilerplate) for each selected clause, such that the selected and designated universally applicable clauses are included, by default, in the contract.

6. An internet-based contract preparation method which employs one or more user interfaces in communication through the internet with a contract preparation and agreement application, wherein the contract preparation and agreement application is accessible and operable, through the one or more user interfaces, by users comprising at least a first party and a second party negotiating a contract, and includes or is capable of accessing a clauses database comprising a plurality of objective clauses, the method comprising the following steps performed by one or both of the first and second parties:
(I) selecting one or more proposed clauses from the clauses database, wherein each clause includes: (1) only standard content, (2) only variable content, or (3) both standard content and variable content;
(II) selecting and/or editing variable content of selected clauses which include variable content;
(III) providing the selected and edited clauses, along with access to the clauses database, to the first party, the second party, or both; and
(IV) reaching agreement on the selected and edited clauses, including their variable content.

7. A method for preparation of a contract by at least a first party and a second party, using a computer application accessed through a user interface in communication through the internet with a computer application which includes or is capable of accessing: a database comprising a plurality of clauses, each of which includes an associated type, standardized content, and certain of which contain editable variable content, at least a first party record which includes a first party name and login credentials, and, optionally, a second party record which includes a second party name and login credentials;
wherein the computer application is capable of allowing one or, optionally, both of the first and second parties:
to access and view all clauses in the list or database,
access and view all universally applicable clauses included by default in the contract,
access and view all variable content of each clause separately from its standardized content,
automatically incorporate universally applicable clauses into the parties' agreement,
select, incorporate and save one or more of proposed clauses from the list or database into the parties' agreement,
edit, incorporate and save any variable content of the selected proposed clauses into the parties' agreement, while not editing any of the clauses' standardized content,
and wherein the computer application is capable of receiving and storing one or more draft agreements which comprise such clauses,
said method comprising the following steps performed by one or, optionally, both of the first and second parties:
(A) drafting, or selecting from the plurality of clauses, each of which has standardized content and, optionally, editable variable content;
(B) editing editable variable content of one or more of the clauses having editable variable content;
(C) optionally, providing the one or more clauses including edited variable content to the first party, the second party, or both,;
(D) optionally, providing the one or more clauses including standardized content to the first party, the second party, or both; and
(E) optionally, viewing the one or more clauses on the website.

8. The method for preparation of a contract of claim 7, wherein the computer application is capable of storing, retrieving and displaying, allowing one or more of the parties to view, and combinations thereof, one or more of the proposed clauses according to the associated type, along with only the associated limited variable content for each selected clause.

9. The method for preparation of a contract of claim 7, wherein the computer application is configured to allow the parties to select alternate views of the selected clauses between viewing only its associated type and its variable content, and viewing the above together with the clause's full standardized content.

10. The method for preparation of a contract of claim 7, wherein the computer application is configured to allow comparison of the preferences for certain variables of each user against other users to match the most highly ranked mutual preference between the users in connection with negotiation of an agreement between those users.

11. The method for preparation of a contract of claim 7, wherein each of the one or more clauses comprise: editable variable content, non-editable standard content, or both.

12. The method for preparation of a contract of claim 7, wherein the computer application comprises an internet-based website or smartphone app which is configured to receive input, data, or user selections made on one or more of a laptop computer, a desktop computer, a computer server, a smartphone, and a pad computing device.

13. The method for preparation of a contract of claim 12, wherein, upon launching the computer application, a first menu is displayed which enables the user to select a type of contract to be prepared, and wherein, when the user selects a type of contract, then the computer application automatically loads and/or displays the selected type of contract.

14. The method for preparation of a contract of claim 12, wherein the computer application displays a first, second, or third menu which includes one or more of a radio button, a dropdown menu, and user interface options for the computer application to receive input from the user on the amount of the contract.

15. The method for preparation of a contract of claim 7, wherein a base contract is displayed in a center of the display and, optionally, one or more variable menu options are displayed at the same time as the base contract, within the contract from a user interface perspective (inline), either to the left or right of the base contract.

16. The method for preparation of a contract of claim 15, wherein a custom provision is provided and displayed, on the right or left side of the user interface display, and allows one or more users to create custom provisions which, upon submission via the computer application, automatically replace one or more existing provisions in the base contract to the custom provision, and changes are shown on the display compared to the replaced existing provisions, and the computer application logs the changes for version control purposes.

17. The method for preparation of a contract of claim 7, wherein the computer application is also configured to allow one or more users access to a workspace for a given transaction or business relationship.

18. The method for preparation of a contract of claim 7, wherein the computer application is configured to receive input via voice control, voice, speech, or voice inputs as well as gestures received via the user interface of a smartphone, pad computer, computing device, or combinations thereof.

19. The method for preparation of a contract of claim 7, wherein the computer application comprises an artificial intelligence engine configured to 1) alert a user of a similar contract provision previously agreed to by a user; 2) develop a custom contract based upon type, geography, and/or amount where the artificial intelligence engine based upon pre-defined and pre-existing contracts or contract provisions is configured to develop a first draft of a contract based upon any combination of type, geography, or amount.

20. The method for preparation, review and agreement of a contract of claim 7, wherein the computer application is configured to receive one or more previously agreed to contracts, wherein the computer application, via the artificial intelligence engine, ingests these contracts, parses provisions of the previously agreed to contracts, and stores the provision based upon the type of contract provision, and/or identifies the most commonly accepted provisions based upon the previously agreed to contracts ingested by the computer application.
